(19) United States
(12) Patent Application Publication
(10) Pub. No.: US 2026/0146567 A1
(43) Pub. Date: May 28, 2026

(54) ENGINE CONTROL OF AN AGRICULTURAL SYSTEM

(71) Applicant: AGCO Power Oy, Innavuori (FL)

(72) Inventor: Eemeli Aaro Antti Pylkkänen, Innavuori, FL (US)

(21) Appl. No.: 19/400,816

(22) Filed: Nov. 25, 2025

(30) Foreign Application Priority Data
Nov. 26, 2024 (GB) 2417354.4

(51) Int. Cl. F02D 29/06; F02D 41/14

(52) U.S. Cl. CPC F02D 29/06; F02D 41/1406; F02D 2200/10

(57) ABSTRACT

An agricultural system includes a drivetrain with an engine, and an electric machine configured to be operated in a motor mode or a generator mode, and a control unit configured to execute a method including determining a maximum total system efficiency of the agricultural system, determining an ideal operation point of the engine in accordance with the maximum total system efficiency, and controlling the engine to operate the engine at the ideal operation point of the engine.

### CROSS-REFERENCE TO RELATED APPLICATION

This application claims the benefit of the filing date of U.K. Patent Application 2417354.4, filed Nov. 26, 2024, the entire disclosure of which is incorporated herein by reference.

### FIELD

The present disclosure relates generally to an engine control of an agricultural system.

### BACKGROUND

An agricultural system operable of agricultural operations in an agricultural field include components providing power such as an internal combustion engine (ICE) to propel the agricultural system or a generator, and components consuming the power such as an implement driven by a power take-off shaft or electrical auxiliaries as a fan, for example. The components providing power as well as the components consuming power operate with different efficiencies depending on their power losses wherein one component may have influence on the efficiency of another component of the agricultural system. Hence, the agricultural system may be operated with a component, e. g. the engine, operating at its most efficient operating point. But such kind of operation of the agricultural system may not provide the most efficient operation of the complete agricultural system.

### BRIEF SUMMARY

Thus, it would be beneficial to provide a control for an agricultural system applicable to improve the efficiency of the complete agricultural system.

According to an aspect of the invention there is provided an agricultural system according to claim 1 and a method according to claim 18. The agricultural system comprises a drivetrain with an engine and an electric machine configured to be operated in a motor mode or a generator mode. The agricultural system further comprises a control unit configured to determine a maximum total system efficiency of the agricultural system, determine an ideal operation point of the engine in accordance with the maximum total system efficiency and control the engine to operate the engine at the ideal operation point of the engine.

The agricultural system may comprise an agricultural vehicle such as a tractor, a harvester, a combine, a sprayer, etc., optionally connected with an implement. The implement may be driven by a power take-off (PTO) shaft to provide mechanical power from the vehicle to the implement. The drivetrain and the control unit may be integrated in the agricultural vehicle. The engine may provide mechanical power in terms of a torque and rotational speed to drive the PTO shaft or other mechanical auxiliaries. Optionally, the engine may propel the vehicle. The drivetrain may also comprise at least one transmission to transform the torque and rotational speed provided by the engine. The vehicle may be a hybrid vehicle comprising an additional electric drive motor which may also propel the vehicle. The drive motor may be part of the drivetrain. The electric machine, e. g. an electric motor, may provide mechanical power when operated in the motor mode and electrical power when operated in the generator mode. The mechanical power provided by the electric machine 208 may be used to drive the PTO shaft or other mechanical auxiliaries. The electrical power generated by the electric machine may be used to supply the electric drive motor or any other electric auxiliary such as a fan. The control unit may be configured to control the operation mode of the electric machine by switching between motor and generator mode. The control unit may also be configured to execute a method for determining a maximum total system efficiency of the agricultural system based on operating parameters of the agricultural system and at least one algorithm. The control unit may also be configured to find the ideal operation point out of multiple operation points of the engine at which the agricultural system can be operated with its maximum total system efficiency. This ideal operation point may be different to the operation point at which the engine can be operated at its maximum engine efficiency. But the ideal operation point of the engine may have a stronger positive effect on the efficiency of the other components of the agricultural system so that the maximum total system efficiency of the agricultural system may be better compared to when the engine is operated at its maximum engine efficiency. Hence, the control unit may improve the engine control to improve the total system efficiency of the agricultural system.

The maximum total system efficiency may be a combined efficiency of the engine and at least one additional component of the agricultural system.

I. e., the control unit considers not only the efficiency of the engine but also the efficiency of at least one additional component of the agricultural system when determining the maximum total system efficiency. For example, the control unit may consider the efficiency of the electric machine operating in generator mode or motor mode, the efficiency of the drive motor, the efficiency of the implement or any other component of the agricultural system that is supplied with mechanical power or electrical power such as the mechanical and electrical auxiliaries. The agricultural system may also comprise an electric energy storage such as a battery, an accumulator or capacitor whose efficiency may be considered by the control unit. Hence, the maximum total system efficiency an overall efficiency of all components considered by the control unit when determining the maximum total system efficiency.

The control unit may be configured to determine a mechanical power request of the agricultural system, and determine the maximum total system efficiency based on the mechanical power request.

Mechanical power may be requested by different components of the agricultural system as for example the electric machine when operating in generator mode, the implement driven by the PTO shaft, the drive motor for propelling the vehicle, or any other mechanical auxiliary of the agricultural system. The mechanical power of each component may be measured by corresponding sensors, for example by means of a torque and/or speed sensor, providing the power requests to the control unit. From driver commands demanded by a driver or human operator to operate the agricultural system, mechanical power may be requested. Based on these different power requests, the control unit may determine the (overall) mechanical power request of the agricultural system.

The agricultural machine may comprise at least one mechanical output wherein the mechanical power request depends on power requested by the at least one mechanical output.

The at least one mechanical output may be an interface to connect any components which may be driven by mechanical power. For example, the at least one mechanical output may be designed as a PTO shaft. When the implement is connected to the PTO shaft, the mechanical power requested by the implement can be determined at the PTO shaft as mechanical output of the agricultural system. Hence, the mechanical power can be determined outside of the component which requests mechanical power.

The control unit may be configured to determine an electrical power request of the agricultural system and determine the maximum total system efficiency based on the electrical power request.

Electrical power may be requested by different components of the agricultural system as for example the electric machine when operating in motor mode, the drive motor for propelling the vehicle, the electric energy storage when being charged, or any other electrical auxiliary of the agricultural system. The electrical power of each component may be measured by corresponding sensors, for example by means of a current and/or voltage sensor, providing the power requests to the control unit. From driver commands demanded by a driver or human operator to operate the agricultural system, electrical power may be requested. Based on these different power requests, the control unit may determine the (overall) electrical power request of the agricultural system.

The agricultural machine may comprise at least one electrical output wherein the electrical power request depends on power requested by the at least one electrical output.

The at least one electrical output may be an interface to connect any components which may be driven by electrical. For example, the electrical output is connected to a power link that is connected to the electric machine and the electric energy storage for transferring power between the electrical components connected with the power link. When the electrical component is connected to the electrical output, the electrical power requested by the electrical component can be determined at the electrical output of the agricultural system. Hence, the electrical power can be determined outside of the component which requests electrical power.

The control unit may be configured to determine an ideal engine torque and an ideal engine speed based on the ideal operation point.

The current engine torque and the current engine speed can be measured by corresponding sensors. If the current values deviate from the ideal values, the control unit may adjust the engine control to operate the engine according to the ideal operation point again to provide the maximum total system efficiency. For example, the control unit adapts the current engine speed according to the ideal engine speed and the current engine torque according to the ideal engine torque. As described above, the ideal operation point depends on the maximum total system efficiency and does not necessarily correspond with the operation point at which the engine can be operated at its maximum engine efficiency.

The control unit may be configured to determine at least two different operation points of the engine, determine a total system efficiency for each of the at least two different operation points of the engine, determine the maximum total system efficiency as the total system efficiency having the highest value out of the determined total system efficiencies.

Hence, the control unit is configured to compare the total system efficiencies provided by different operation points of the engine to find the operation point providing the total system efficiency having the maximum value out of all different operation points. The total system efficiency of each of the operation points may depend on power losses of the engine and additional components of the agricultural system when the engine is operated with the corresponding operation point. I. e., each determined total system efficiency is a combination of the efficiency of the engine and the efficiency of at least one additional component of the agricultural system. The efficiency of each component of the agricultural system including the engine can be determined by the control unit based on operating parameters of the agricultural system including the power losses of its components and at least one algorithm. For example, the control unit may calculate the power losses of the engine, the electric machine (when operating in generator mode or motor mode) and the electric energy storage to determine the total system efficiency. The control unit may also consider the (theoretical) chemical power of the fuel combusted by the engine for determining the total system efficiency.

Each of the at least two operation points of the engine may satisfy the mechanical power request to be provided by the engine.

Hence, when determining the total system efficiencies provided by the different operation points of the engine, the control unit may ignore operation points of the engine which cannot satisfy constraints of the agricultural system such as the mechanical power request. So, the number of total system efficiencies can be reduced to the number of operation points applicable to satisfy the constraints of the agricultural system to improve the performance of the method or the algorithm executed by the control unit.

The control unit may be configured to determine the ideal operation point as operation point of the engine providing the total system efficiency having the highest value out of the determined total system efficiencies.

Hence, the control unit is configured to find the ideal operation point based on the comparison of the total system efficiencies provided by different operation points of the engine to find the operation point providing the total system efficiency having the maximum value out of all different operation points. This operation point will be chosen by the control unit as ideal operation point of the engine for providing the maximum total system efficiency.

The control unit may be configured to determine a set engine state of the engine based on the maximum total system efficiency, and switch on or switch off the engine according to the set engine state.

The control unit may switch off the engine if the maximum total system efficiency falls below a lower threshold value and switch on the engine if the maximum total system efficiency exceeds a higher threshold value being higher than the lower threshold value. The control unit may also decide to change the engine state based on the SOC of the electric energy storage and the current engine state. Hence, the engine is controlled in a most efficient way in respect of the operating conditions of the complete agricultural system.

The control unit may be configured to determine an ideal operation point of the electric machine for operating the electric machine in the generator mode, and control the electric machine in the generator mode at the ideal operation point if the engine is switched on.

The ideal operation point of the electric machine may be specified by the manufacturer of the electric machine and may be a parameter stored in a memory of the control unit. When the engine is switched on, the mechanical power provided by the engine can be transformed by the electric machine in electrical power when the electric machine operates in generator mode. The electric power can be used to charge the electric energy storage and/or to provide electrical power to at least one of the electrical auxiliaries/consumers of the agricultural system. Since the maximum total system efficiency has exceeded the higher threshold value when the engine is driven, power losses due to the transformation of the mechanical power to the electrical power can be reduced compared to an operation at lower maximum total system efficiency. I. e., the control unit may decide to generate electrical power when a sufficient level of total system efficiency of the agricultural system can be provided to avoid excessive power losses for the transformation of energy.

The control unit may be configured to determine an ideal operation point of the electric machine for operating the electric machine in the motor mode, and control the electric machine in the motor mode at the ideal operation point if the engine may be switched off.

As mentioned before, the ideal operation point of the electric machine may be specified by the manufacturer of the electric machine and may be a parameter stored in a memory of the control unit. When the engine is switched off, no mechanical power is transferred from the engine to the electric machine for generating electrical power. In this case, electrical power may be drawn from the electric energy storage to operate the electric machine in motor mode. Additionally, the drive motor and the other electrical auxiliaries may be supplied with electric power from the electric energy storage. While the maximum total system efficiency does not exceed the higher threshold value and/or the SOC of the electric energy storage does not fall below a minimum value, the engine may be kept switched off. I. e., the control unit may decide to switch on the engine when a sufficient level of total system efficiency of the agricultural system can be provided to avoid excessive power losses for the transformation of mechanical energy provided by the engine to electrical energy.

As mentioned before, the agricultural machine may comprise an electric energy storage wherein the control unit may be configured to determine a state of charge (SOC) of the electric energy storage.

The SOC may be measured by a corresponding sensor connected with the control unit. The SOC may represent a value between a fully charged and a fully emptied electric energy storage. The SOC may then be considered by the control unit to adjust the control of the engine according to different SOC levels of the electric energy storage. For example, the control unit may switch on or off the engine based on specific SOC levels or adjust the operation point of the engine in respect of specific SOC levels.

The control unit may be configured to control the engine to operate at the ideal operation point of the engine if the state of charge of the electric energy storage may be between an upper charge threshold and a lower charge threshold, at an operation point providing more power than at the ideal operation point if the state of charge of the electric energy storage may be smaller than the lower charge threshold, and at an operation point providing less power than at the ideal operation point if the state of charge of the electric energy storage may be greater than the upper charge threshold.

For some system constraints, the ideal operation point of the engine determined by the control unit may not be feasible due to power limitations. Therefore, the control unit may control the engine to operate at an operation point being different from the ideal operation point. The decision to operate at a different operation point may depend on the SOC of the electric energy storage. For example, a faster charging of the electric energy storage can be achieved if the engine is operated at an operation point providing more mechanical power than the ideal operation point. This kind of operation may be used if the SOC has been fallen below a minimum charge level defined by a lower charge threshold. For reasons of a longer lifetime of the electric energy storage, the engine may be operated at an operation point providing less mechanical power than the ideal operation point. This kind of operation may be used if the SOC has exceeded a maximum charge level defined by an upper charge threshold. Hence, the control unit may also react to satisfy any power limitations of the agricultural system and to use the best achievable total system efficiency even in these situations.

The control unit may be configured to determine the set engine state of the engine additionally based on the state of charge of the electric energy storage.

Operating the electric energy storage at insufficient SOC or excessive charging of the electric energy storage may reduce the lifetime of the electric energy storage. Hence, the control unit may decide to switch on or off the engine also in dependence of providing an appropriate SOC for a longer lifetime of the electric energy storage. I. e., the control unit may set the set engine state to “engine on” if the SOC is below a lower threshold or to “engine off” if the SOC is exceeding an upper threshold.

The control unit may be configured to determine a current engine state of the engine, and determine the set engine state of the engine additionally based on the current engine state of the engine.

Excessive switching the engine state between engine on and engine off may reduce the lifetime of some components of the engine or also other components driven by the engine. Hence, switching of the engine state may be reduced to an appropriate number when the current engine state is considered by the control unit. For example, the control unit may delay a change of the engine state if a time point of a previous change of the engine state is too short or if a total number of changes of the engine state has been exceeded. Hence, lifetime may be extended.

Another aspect includes a method for controlling an engine. The method comprises steps for determining a maximum total system efficiency of the agricultural system, determining an ideal operation point of the engine in accordance with the maximum total system efficiency, and controlling the engine to operate the engine at the ideal operation point of the engine.

As disclosed above, the control unit is configured to execute different actions. Each action may be implemented as one or more method steps of the method executable by the control unit. Hence, each action for which the control unit is configured to execute may be defined as a method step.

Within the scope of this application, it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

Several aspects of the invention will now be described, by way of example only, with reference to the accompanying drawings, in which:

FIG. 1 illustrates a schematic block diagram of an agricultural machine.

FIG. 2 illustrates a schematic block diagram of a drivetrain of the agricultural machine.

FIG. 3 illustrates a simplified view of a control unit.

FIG. 4 illustrates schematically a control scheme of the control unit.

FIG. 5 illustrates a flow chart of a method executable by the control unit.

FIG. 6 shows exemplarily a total system efficiency map.

FIG. 7 shows exemplarily an engine efficiency map of the engine.

FIG. 8 illustrates a diagram of the engine state of the engine.

### DETAILED DESCRIPTION

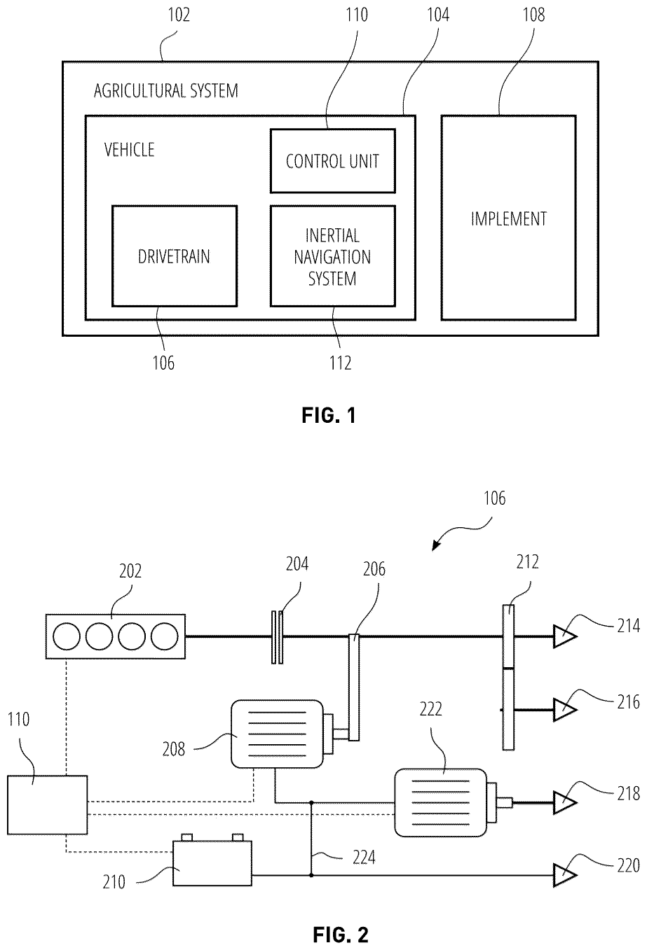

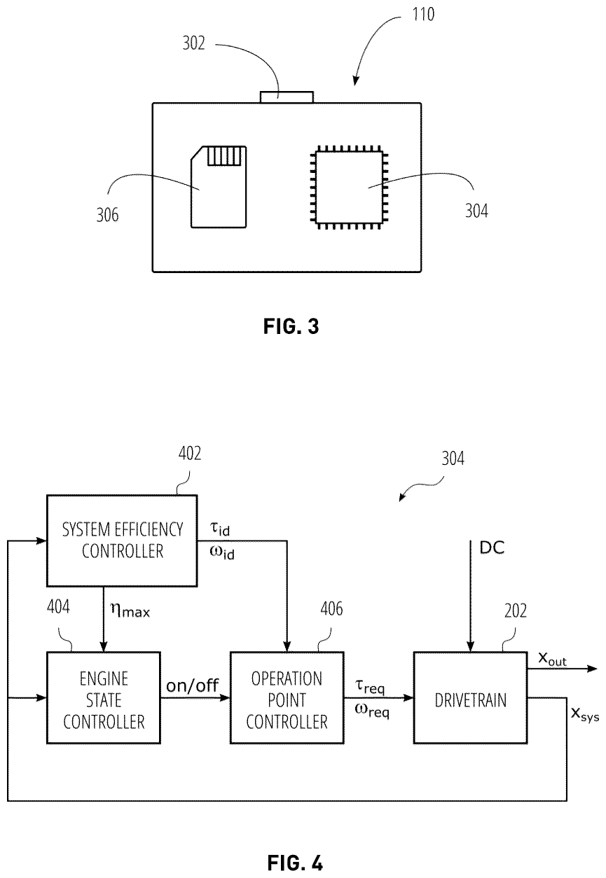

FIG. 1 shows a simplified block diagram of an agricultural system 102. The agricultural system 102 may be a vehicle 104 or a vehicle-implement combination (104, 108). The vehicle 104 may be an agricultural vehicle such as a tractor, a harvester, a combine, a sprayer or of any other type such as a truck. The vehicle 104 may generate a tractive force to tow an implement 108 through an agricultural field. The implement 108 may be fixed to the vehicle 104 or detachably connected with the vehicle 104. The implement 108 may be used for an operation in the agricultural field and may be of the type of a plough, a rake, a planter, a sprayer, a mower, a trailer, etc. Depending on the type of the implement 108, the implement 108 may comprise one or more tools such as a rake rotor, a mower knife, a seeding unit, a spray nozzle, a shovel, a dumper, etc. The agricultural system 102 comprises also a control unit 110 as shown in FIG. 3, a drivetrain 106 as shown in FIG. 2 and an inertial navigation system (INS) 112.

The inertial navigation system 112 provides position and time signals for determining an absolute position of the agricultural system 102 at a specific point of time. The inertial navigation system 112 may comprise an inertial measurement unit (IMU) with a gyroscope for determining a vehicle speed, a vehicle acceleration and/or an inclination a of the vehicle 104. The inertial navigation system 112 may also comprise a global navigation satellite system (GNSS) receiver receiving position and time signals from a GNSS such as GPS or Galileo. The IMU may provide additional orientation information about the orientation and movement of the agricultural system 102 for improving the accuracy of the position estimation and the reference points of the GNSS receiver. Based on received position and time signals, the agricultural system 102 can move autonomously along a travel path.

FIG. 2 shows the drivetrain 106 of the agricultural system 102 comprising an engine 202, a clutch 204, an electric machine 208, an electric energy storage 210, an (electric) drive motor 222 for propelling the vehicle 104 of the agricultural system 102, at least one mechanical output 214, 216, 218 providing mechanical power (torque and rotational speed) and at least one electrical output 220 providing electric power (current and voltage). The mechanical outputs 214, 216 and 218 may be connected via optional transmissions with a drive axle of the vehicle 104, a power take-off shaft of the vehicle 104 or any other auxiliary such as a hydraulic pump. Outputs 214 and 216 are driven by the engine 202 if the clutch 204 is closed. A gear drive 212 is integrated between the engine 202 and the output 216 and may transform the torque and the speed transferred from the engine 202 to the output 216. Moreover, the electric machine 208 is mechanically connected with the engine 202 and the outputs 214 and 216 by means of a belt drive 206 or any other type of transmission.

The electric machine 208 may operate in a motor mode to provide mechanical power to the outputs 214 and 216 analogously to the engine 202. The mechanical power provided by the engine 202 and the electric machine 208 may be accumulated if the clutch 204 is closed. Otherwise, mechanical power transferred to the mechanical outputs 214 and 216 is provided by the electric machine 208 only. Alternatively, the electric machine 208 may operate in a generator mode when driven by mechanical power provided by the engine 202 and transferred via the closed clutch 204 and the belt drive 206. Then, the electric machine 208 transforms the mechanical power received from the engine 202 to electrical power.

The electrical power may be transferred and distributed via a common electric power link 224 connected with the electric machine 208, the drive motor 222, the electric energy storage 210 and the electrical output 220. Hence, electrical power may be stored in the electric energy storage 210, transferred to the drive motor 222 for driving the mechanical output 218 and/or provided to the electrical output 220. The electric energy storage 210 may be an accumulator, a battery, a capacitor or any other component configured to store and provide electrical power.

The control unit 110 is connected with several components of the agricultural system 102 such as the engine 202, the electric machine 208, the drive motor 222 and the electric energy storage 210 to receive parameters of the agricultural system 102 and/or to control components of the agricultural system 102. For example, the control unit 110 may receive the state of charge (SOC) of the electric energy storage 210, control the electric machines 208 in generator mode or in motor mode, control the drive motor 222, control the engine 202 and receive operational parameters of the engine 202, the electric machine 208 and/or the drive motor 222.

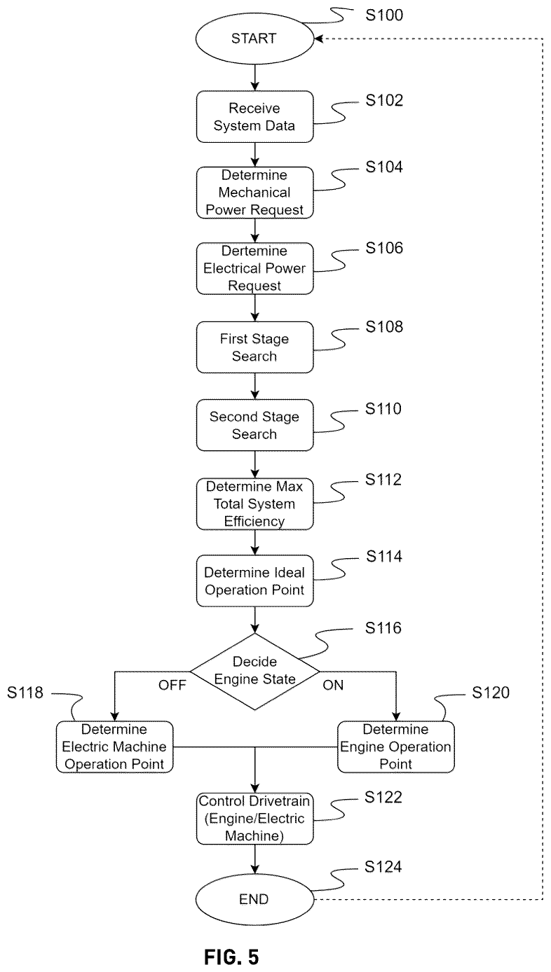

FIG. 3 shows schematically the control unit 110 comprising an I/O interface 302, a combination of at least one controller 304 and a memory 306. The I/O interface 302, the combination of at least one controller 304 and the memory 306 may be attached to a printed circuit board (PCB). The control unit 110 may receive and send signals or data via the I/O interface 302. The I/O interface 302 may be a wireless interface or a connector. The combination of at least one controller 304 comprises a system efficiency controller 402, an engine state controller 404 and an operation point controller 406 connected to each other as shown in FIG. 4. The combination of at least one controller 304 may store the data or signals received by the control unit 110 in the memory 306. The memory 306 may contain additional data or executable computer program products, for example in terms of a computer-implemented method, that may be retrieved, processed or executed by the combination of at least one controller 304. Data or signals resulting from the processing of data or signals or from the execution of a computer program product may be stored to the memory 306 or sent to the I/O interface 302 by the combination of at least one controller 304. Regardless of FIG. 3 exemplarily illustrating the control unit 110 as a standalone control unit, the control unit 110 may represent a network of multiple control units distributed within the system.

FIG. 5 shows a flow chart of a method for controlling the engine 202 and the electric machine 208 of the drivetrain 106 of the agricultural system 102 (see FIG. 1 and FIG. 2) to operate the agricultural system 102 not only considering the efficiency of the engine 202 but the efficiency of the whole agricultural system 102. The method may be at least partly a computer-implemented method stored as a computer program product in the memory 306 of the control unit 110. The control unit 110 is configured to carry out the method. Computer-implemented parts of the method may be executed by the combination of at least one controller 304 including the system efficiency controller 402, the engine state controller 404 and the operation point controller 406 of the control unit 110. Non-computer-implemented parts of the method may be executed manually or by other components of the system. The method is described by way of example of several steps without any restriction in respect of the steps. That is, the number or the order of steps may be adapted, for example single steps may be excluded and/or added and executed earlier or later than described. When the method proceeds from one step to a next step, the previous step may still be active so that both the one and the next step may be executed in parallel. Accordingly, the control unit may execute two or more method steps in parallel.

The method starts at step S100 and proceeds to step S102. At step S102, the control unit 110 receives system data x_{sys} such as state of charge (SOC) of the electric energy storage 210, temperature of the electric energy storage 210, active gear ratio of the gear drive 212, and current engine state of the engine 202 (engine on/engine off). The system data x_{sys} may be determined by corresponding sensor units of the drivetrain 106 and sent to the system efficiency controller 402 and the engine state controller 404 as exemplarily shown in FIG. 4. The system data x_{sys} may depend on driver commands DC commanding the drivetrain 106 to generate output power xₒᵤₜ for the outputs 214 to 220. For example, the driver of the agricultural system 102 may control the electric drive motor 222 of the drivetrain 106 to accelerate the vehicle 104 of the agricultural system 102 wherein the additional required electric power for the drive motor 222 may reduce the SOC and increase the temperature of the electric energy storage 210.

The method proceeds to step S104 and the control unit 110 determines the mechanical power request of the agricultural system 102. The mechanical power request depends on the power requested by the at least one mechanical output 214, 216, 218 and can be measured by corresponding sensor units. For example, an implement 108 connected to mechanical output 216 may require a specific amount of mechanical power in terms of rotational speed and torque for an operation in the agricultural field. The rotational speed and the torque can be measured and corresponding sensor signals can be sent to the control unit 110 and provided for the system efficiency controller 402 and the engine state controller 404 analogously to the system data x_{sys}. Analogously, a mechanical power request required by output 218 to propel the vehicle 104 of the agricultural system 102 can be determined. Accordingly, the control unit 110 can determine the total mechanical power request P_{mech} of the agricultural system 102.

The method proceeds to step S106 and the control unit 110 determines the electrical power request of the agricultural system 102. The electrical power request depends on the power requested by the at least one electrical output 220 and can be measured by corresponding sensor units. For example, an electrical auxiliary such as a fan connected to electrical output 220 may require a specific amount of electrical power in terms of current and voltage. Analogously to the mechanical output 216, a mechanical power request required by output 218 to propel the vehicle 104 of the agricultural system 102 can be determined. Since the required mechanical power for output 218 is provided by the electric drive motor 222 supplied with electrical power, the power request of output 218 can be considered as electrical power request. Accordingly, the control unit 110 can determine the total electrical power request P_{elec} of the agricultural system 102.

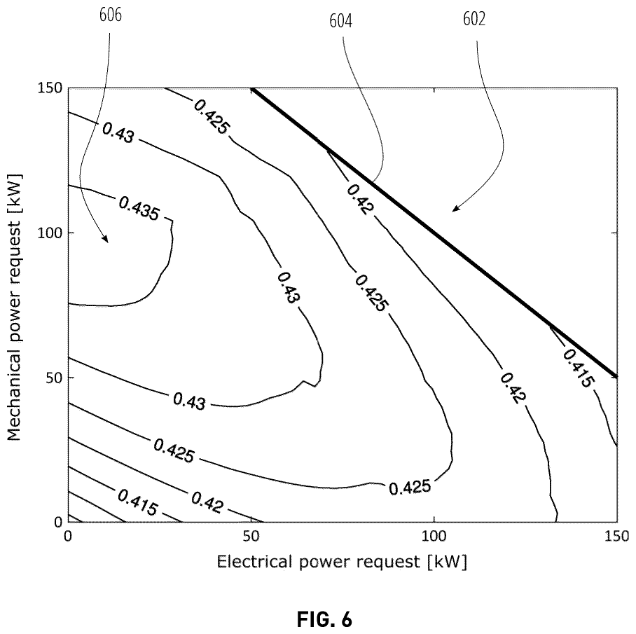

The method proceeds to steps S108 and S110 to perform a two stage search for determining a maximum total system efficiency ηₘₐₓ of the agricultural system 102. As can be seen in FIG. 6 showing an exemplary total system efficiency map 602 for the agricultural system 102, the total system efficiency depends on the total mechanical power request P_{mech} and the total electrical power request P_{elec} of the agricultural system 102. The maximum power output of the agricultural system 102 is indicated by reference numeral 604. The different system efficiency values are shown as isolines in the total system efficiency map 602. As can be seen, in case of low mechanical and electrical power requests P_{mech} and P_{elec}, the total system efficiency is low since the engine 202 cannot operate with its optimal brake specific fuel consumption (BSFC). Also, in this region the electric energy storage 210 may be charged with relatively high electrical power. Thus, the power losses of the electric energy storage 210 and the electric machine 208 operating in generator mode are significant. When the mechanical and electrical power requests P_{mech} and P_{elec} are high, the same phenomenon of a poor BSFC happens with the engine 202. Additionally, the electric energy storage 210 may be discharged with high electrical power resulting in high power losses of the electric energy storage 210. Instead, the highest total system efficiencies can be achieved when the agricultural system 102 is operated in a field of highest system efficiency 606, for example when the electrical power request is close to zero kW and the mechanical power request is close to 100 kW. Then, the engine 202 can operate with its optimal BSFC. Additionally, the power losses of the electric machine 208 operating in generator mode and the power losses of the electric energy storage are low due to the low total electrical power request P_{elec}.

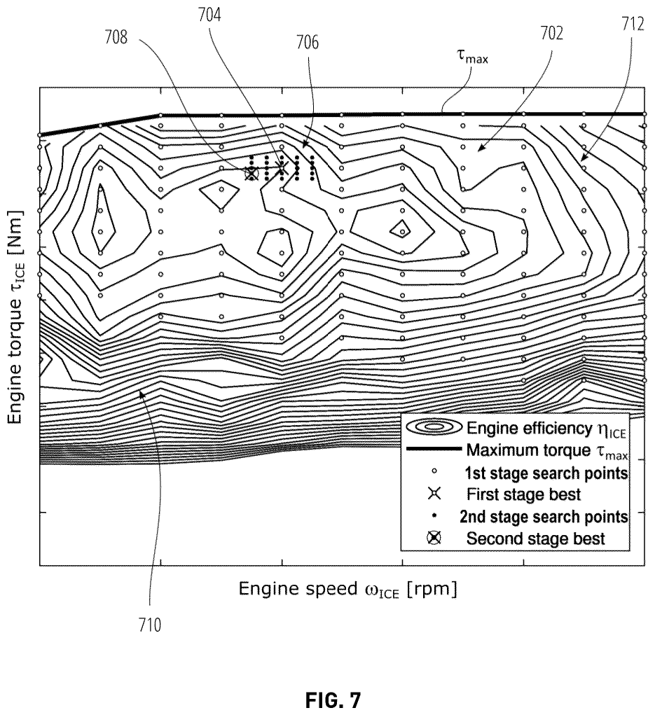

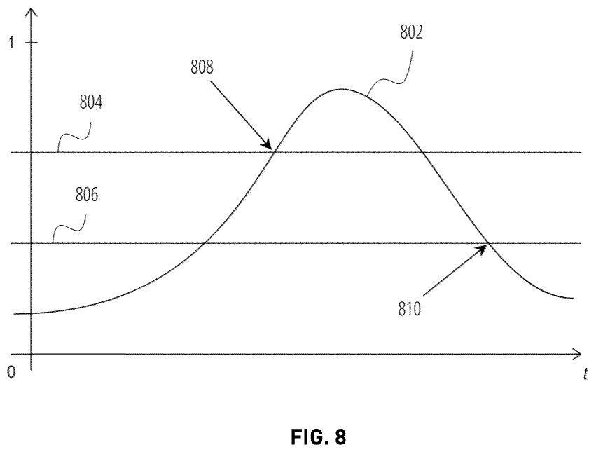

The maximum total system efficiency ηₘₐₓ is determined by the two stage search. The two stage search comprises a first stage search according to step S108 and a second stage search according to S110 and will be explained in the following by way of example of FIG. 7 showing exemplarily an engine efficiency map with different efficiency values η_{ICE} of the engine 202 represented by BSFC isolines (limited by the maximum engine torque τₘₐₓ).

As can be seen in FIG. 7, the engine efficiency map includes first stage search points 702 and second stage search points 706. Each of the first and second stage search points 702 and 706 represent an operation point of the engine 202 defined by an engine speed ω_{ICE} and an engine torque τ_{ICE} of the engine 202. The first stage search points 702 may be predefined and stored in the memory 306 of the control unit 110 or calculated by the control unit 110. The second stage search points 706 are determined by the control unit 110 in respect of a single first stage search point as described later.

At step S108, the system efficiency controller 402 of the control unit 110 selects the first stage search points out of all first stage search points 702 which satisfy the system constraints. The system constraints may for example include power limits (e. g. maximum charging/discharging power of the electric energy storage 210, maximum power of the electric machine 208, maximum power of the engine 202, etc.), speed limits (e. g. maximum speeds of the engine 202 and the electric machine 208, speed requirements of any mechanical output 214, 216, 218) and torque limits (e. g. maximum torque of the engine 202 and the electric machine 208). Then, the system efficiency controller 402 determines a total system efficiency ηₜₒₜ for each of the selected first stage search points.

The total system efficiency ηₜₒₜ can be calculated based on power losses of the engine 202 P_{loss,ICE}, power losses of the electric machine 208 P_{loss,Gen}, power losses of the electric energy storage 210 P_{loss,EES} and the (theoretical) chemical power of the fuel P_{fuel} combusted by the engine 202 according to equation 1:

$${η}_{tot} = 1 - \frac{{P}_{loss , ICE} + {P}_{loss , Gen} + {P}_{loss , EES}}{{P}_{fuel}} . \qquad ( equation 1 )$$

The power losses of the engine P_{loss,ICE}, and the fuel flow are dependent on the engine speed ω_{ICE} and engine torque τ_{ICE} of the engine 202. These operational parameters are control variables, and therefore known by the control unit 110.

The power of the electric machine 208 P_{Gen} can be calculated according to equation 2:

$${P}_{Gen} = {P}_{mech} - {P}_{ICE} . \qquad ( equation 2 )$$

P_{mech} is the total mechanical power request of the agricultural system 102 determined at step S104 and P_{ICE} is the engine power of the engine 202.

The power losses of the electric machine 208 P_{loss,Gen} depend on the rotational speed ω_{Gen} and torque τ_{Gen} of the electric machine 208 (operating in generator mode). The electric machine 208 is mechanically connected to the engine 202 by means of the belt drive 206. Thus, the rotational speeds of the engine 202 and the electric machine 208 are proportional. The torque τ_{Gen} of the electric machine 208 can be calculated according to equation 3:

$${τ}_{Gen} - \frac{{P}_{Gen}}{{ω}_{Gen}} . \qquad ( equation 3 )$$

The power of the electric energy storage 210 P_{EES} can be calculated according to equation 4:

$${P}_{EES} = {P}_{elec} + {P}_{Gen} + {P}_{loss , Gen} . \qquad ( equation 4 )$$

P_{elec} is the total electrical power request of the agricultural system 102 determined at step S106.

The power losses of the electric energy storage 210 P_{loss,EES} can then be calculated according to equations 5 and 6:

$${I}_{EES} = \frac{{U}_{OC} - \sqrt{{U}_{OC}^{2} - 4 \times {P}_{EES} \times {R}_{EES}}}{2 \times {R}_{EES}} \qquad ( equation 5 )$$

$$and$$

$${P}_{loss , EES} = {R}_{EES} \times {I}_{EES}^{2} \qquad ( equation 6 )$$

wherein U_{OC} is the open circuit voltage of the electric energy storage 210 and REES is the internal resistance of the electric energy storage 210. The open circuit voltage U_{OC} can be measured by a voltage sensor or alternatively calculated by means of a battery map. It is dependent on SOC and temperature of the electric energy storage 210. The internal resistance of the electric energy storage 210 REES is dependent on SOC, temperature and charging state of the electric energy storage 210 (charging/discharging). Also, this parameter can be measured by a sensor or calculated by means of battery maps. Since the battery power loss is calculated only one way, an additional loss is added to the calculation to describe the fact that when the energy flow is eventually reversed, there are also losses involved. Since the equations 1 to 6 are stored in the memory 306 of the control unit 110, the system efficiency controller 402 can determine the total system efficiency ηₜₒₜ for each of the selected first stage search points according to equation 1 in combination with the equations 2 to 6 and based on the system data x_{sys} determined at step S102 as well as the engine speed ω_{ICE} and the engine torque τ_{ICE} of the engine 202 defined by the corresponding first stage search point.

Then, the system efficiency controller 402 of the control unit 110 compares the determined total system efficiency ηₜₒₜ values of all of the selected first stage search points with each other to determine the first stage search point having the highest total system efficiency ηₜₒₜ out of all of the first stage search points 702 satisfying the system constraints as first stage best value 704. As can be seen in FIG. 7, a first stage best value 704 has been determined by the control unit 110.

The method proceeds to step S110 and the control unit 110 executes the second stage search for refining the result of the first stage search. At this step, the system efficiency controller 402 determines second stage search points 706 surrounding the first stage best value 704. I. e., each of the second stage search points 706 represent an operation point of the engine 202 defined by a slower or higher engine speed DICE than the engine speed of the first stage best value 704 and a higher or lower engine torque τ_{ICE} than the torque of the first stage best value 704. The deviations from the first stage best value 704 may be defined by predefined ranges stored in the memory 306 of the control unit 110. For example, the second stage search points may represent operation points within an engine speed range of plus or minus 100 revolutions per minute (rpm) in respect of the engine speed of the first stage best value 704, and within an engine torque range of plus or minus 20 Newton meter (Nm) in respect of the torque of the first stage best value 704. Depending on the deviations, the second stage search points 706 may be arranged in a specific shape, e. g. in a rectangular matrix, and may be specifically oriented in respect of the first stage best value 704, e. g. surrounding the first stage best value 704 as a center point. Other shapes (e. g. a circle) and/or orientations including the number of the second stage search points 706 are possible and can be stored as predefined parameters in the memory 306.

Then, the system efficiency controller 402 determines the second stage search point having the highest total system efficiency 1) tot out of all of the second stage search points 706 satisfying the system constraints as second stage best value 708 based on a comparison of the total system efficiencies ηₜₒₜ of all of the second stage search points 706 wherein the total system efficiency ηₜₒₜ of each second stage search point is determined according to equation 1 and based on the system data x_{sys} determined at step S102 as well as the engine speed ω_{ICE} and the engine torque τ_{ICE} of the engine 202 defined by the corresponding second stage search point analogously to step S108 for determining the first stage best values 704.

The method proceeds to step S112 and the system efficiency controller 402 determines the total system efficiency of the second stage best value 708 as maximum total system efficiency ηₘₐₓ.

The method proceeds to step S114 and the system efficiency controller 402 determines the second stage best value 708 as the ideal operation point that corresponds with the maximum total system efficiency ηₘₐₓ. The ideal operation point is defined by the ideal engine speed ωid and ideal engine torque τ_{id} of the engine 202. The ideal operation point may be different to the optimal engine operation point for operating the engine 202 at its best BSFC value since the ideal operation point considers not only the power losses of the engine 202 but also the power losses of additional components of the agricultural system 102 such as the electric machine 208 and the electric energy storage 210. So, the maximum total system efficiency ηₘₐₓ depends on operations of the agricultural system 102 and other factors. The agricultural system 102 can output power through different routes, such as directly from the shaft of the engine 202 or through the power link 224. Therefore, the maximum total system efficiency Ilmar depends on the way the power is taken out of the agricultural system 102.

After the determination of the maximum total system efficiency ηₘₐₓ and the corresponding ideal operation point (ideal engine speed ω_{id}, ideal engine torque τ_{id}), the method proceeds to step S116 and the control unit 110 decides to switch on or switch off the engine 202. The decision may be taken by the engine state controller 404 of the control unit 110 receiving the maximum total system efficiency ηₘₐₓ from the system efficiency controller 402. The decision is also influenced by additional system data x_{sys} as the SOC of the electric energy storage 210 and the current engine state (see FIG. 4). For example, the SOC of the electric energy storage 210 should be maintained within specified SOC limits and the engine 202 should be switched on when the maximum total system efficiency ηₘₐₓ corresponds with a high total system efficiency of the agricultural system 102, as for example if the maximum total system efficiency ηₘₐₓ is in or close to the field of highest system efficiency 606 (see FIG. 6). Also, excessive switching between both engine states (on, off) should be avoided. Thus, the current engine state is taken into account by the engine state controller 404.

To achieve satisfactory control behavior, the system data x_{sys} may be weighted and may have different dependencies. Accordingly, the SOC of the electric energy storage 210 and a SOC set point may be scaled between a range of −1 to 1 since a minor number of discrete SOC levels such as low, medium and high would not be precise enough. The maximum total system efficiency ηₘₐₓ may be scaled between a range of 0 and 1. For the aforementioned reasons, the engine state controller 404 may be implemented as a fuzzy logic controller. Based on the maximum total system efficiency ηₘₐₓ, the SOC of the electric energy storage 210 and the current engine state of the engine 202, the engine state controller 404 may determine a fuzzy inference system output 802 between 0 and 1 which describes what the engine state of the engine 202 should be, as exemplarily illustrated in FIG. 8. The engine state controller 404 may compare the fuzzy inference system output 802 with an upper threshold 804 and a lower threshold 806. If the fuzzy inference system output 802 exceeds the upper threshold 804 at a switch on point 808, the control unit 110 determines a set engine state to “engine on”. If the fuzzy inference system output 802 falls below the lower threshold 806 at a switch off point 810, the control unit 110 determines the set engine state to “engine off”.

If the control unit 110 has decided to switch the engine 202 off, the method proceeds with step S118. If the control unit 110 has decided to switch the engine 202 on, the method proceeds with step S120. Both, steps S118 and S120 are executed by the operation point controller 406 of the control unit 110. The operation point controller 406 receives the ideal operation point of the engine 202 (corresponding with the second stage best value 708) defined by the ideal engine speed ω_{id} and ideal engine torque τ_{id} of the engine 202 (see step S114) from the system efficiency controller 402 and the set engine state from the engine state controller 404.

At step S118, the operation point controller 406 determines the electric machine operation point of the electric machine 208. The electric machine operation point may be the ideal operation point of the electric machine 208 that may be predefined by parameters stored in the memory 306 of the control unit 110. For example, the ideal operation point of the electric machine 208 may have been specified by the manufacturer of the electric machine 208. The control unit 110 may choose the electric machine operation point of the electric machine 208 based on the electrical power request P_{elec} and the mode of operation of the electric machine 208 (generator mode or motor mode) to operate the electric machine 208 at step S122 accordingly. Then, the method proceeds to step S122.

At step S120, the operation point controller 406 determines the engine operation point of the engine 202 based on the SOC of the electric energy storage 210 and the ideal operation point of the engine 202 (corresponding with the second stage best value 708) determined at step S114.

If the SOC of the electric energy storage 210 is between an upper charge threshold SOCₘₐₓ and a lower charge threshold SOCₘᵢₙ, the control unit 110 determines the ideal operation point as the engine operation point defined by the ideal engine speed ω_{id} and ideal engine torque τ_{id} as determined at step S114. Consequently, the agricultural system 102 will be operated at its maximum total system efficiency.

If the SOC of the electric energy storage 210 is below the lower charge threshold SOCₘᵢₙ, the control unit 110 determines an engine operation point that provides more mechanical power than the ideal operation point of the engine 202 but less total system efficiency than the maximum total system efficiency. Such an operation point may be located in a more right and upper area 712 of the engine efficiency map (see FIG. 7) compared to the second stage best value 708. Then, the engine 202 will provide more mechanical power to drive the electric machine 208 in generator mode for generating more electrical power to charge the electric energy storage 210.

If the SOC of the electric energy storage 210 is exceeding the upper charge threshold SOCₘₐₓ, the control unit 110 determines an engine operation point that provides less mechanical power than the ideal operation point of the engine 202. Such an operation point may be located in a more left and lower area 710 of the engine efficiency map (see FIG. 7) compared to the second stage best value 708. Then, the engine 202 will provide less mechanical power to avoid excessive charging of the electric energy storage 210.

Hence, the engine operation point may deviate from the ideal operation point of the engine 202 for some situations. In these situations, the engine operation point is adjusted to satisfy power limitations of the agricultural system. Thus, it is possible to use the best achievable total system efficiency even in these situations. Then, the method proceeds to step S122.

At step S122, the control unit 110 switches the engine 202 off or on in accordance with the set engine state determined at step S116. In case of a set engine state “engine off”, the control unit 110 controls the electric machine 208 of the drivetrain 106 according to the electric machine operation point as determined at step S118. In case of a set engine state “engine on”, the control unit 110 controls the engine 202 of the drivetrain 106 according to the engine operation point as determined at step S120. Then, the method proceeds to step S124.

At step S124, the method ends and may be restarted again.

All references cited herein are incorporated herein in their entireties. If there is a conflict between definitions herein and in an incorporated reference, the definition herein shall control.

LISTING OF DRAWING ELEMENTS

| | |
|---|---|
| 102 agricultural system | 114 imaging unit |
| 104 vehicle | 202 engine |
| 106 drivetrain | 204 clutch |
| 108 implement | 206 belt drive |
| 110 control unit | 208 electric machine |
| 112 inertial navigation system | 210 electric energy storage |
| 212 gear drive | 604 maximum power output |
| 214 output | 606 field of highest system efficiency |
| 216 output | 702 first stage search points |
| 218 output | 704 first stage best value |
| 220 output | 706 second stage search points |
| 222 drive motor | 708 second stage best value |
| 224 power link | 710 area |
| 302 I/O interface | 712 area |
| 304 combination of at least one | 802 fuzzy inference system output |
| controller | |
| 306 memory | 804 threshold |
| 402 system efficiency controller | 806 threshold |
| 404 engine state controller | 808 switch on point |
| 406 operation point controller | 810 switch off point |
| 602 total system efficiency map | |

What is claimed is:

1. An agricultural system, comprising:
a drivetrain with
an engine; and
an electric machine configured to be operated in a motor mode or a generator mode;
the agricultural system further comprising
a control unit configured to
determine a maximum total system efficiency of the agricultural system;
determine an ideal operation point of the engine in accordance with the maximum total system efficiency;
control the engine to operate the engine at the ideal operation point of the engine.

2. The agricultural machine of claim 1, wherein the maximum total system efficiency is a combined efficiency of the engine and at least one additional component of the agricultural system.

3. The agricultural machine of claim 1, wherein the control unit is configured to
determine a mechanical power request of the agricultural system; and
determine the maximum total system efficiency based on the mechanical power request.

4. The agricultural machine of claim 3, comprising at least one mechanical output; wherein
the mechanical power request depends on power requested by the at least one mechanical output.

5. The agricultural machine of claim 1, wherein the control unit is configured to
determine an electrical power request of the agricultural system; and
determine the maximum total system efficiency based on the electrical power request.

6. The agricultural machine of claim 5, comprising at least one electrical output; wherein
the electrical power request depends on power requested by the at least one electrical output.

7. The agricultural machine of claim 1, wherein the control unit is configured to determine an ideal engine torque and an ideal engine speed based on the ideal operation point.

8. The agricultural machine of claim 1, wherein the control unit is configured to
determine at least two different operation points of the engine;
determine a total system efficiency for each of the at least two different operation points of the engine;
determine the maximum total system efficiency as the total system efficiency having the highest value out of the determined total system efficiencies.

9. The agricultural machine of claim 8, wherein each of the at least two operation points of the engine satisfies a mechanical power request to be provided by the engine.

10. The agricultural machine of claim 8, wherein the control unit is configured to
determine the ideal operation point as operation point of the engine providing the total system efficiency having the highest value out of the determined total system efficiencies.

11. The agricultural machine of claim 1, wherein the control unit is configured to
determine a set engine state of the engine based on the maximum total system efficiency; and
switch on or switch off the engine according to the set engine state.

12. The agricultural machine of claim 11, wherein the control unit is configured to
determine an ideal operation point of the electric machine for operating the electric machine in the generator mode; and
control the electric machine in the generator mode at the ideal operation point if the engine is switched on.

13. The agricultural machine of claim 11, wherein the control unit is configured to
determine an ideal operation point of the electric machine for operating the electric machine in the motor mode; and
control the electric machine in the motor mode at the ideal operation point if the engine is switched off.

14. The agricultural machine of claim 1, comprising
an electric energy storage; wherein
the control unit is configured to
determine a state of charge of the electric energy storage.

15. The agricultural machine of claim 14, wherein
the control unit is configured to control the engine to operate
at the ideal operation point of the engine if the state of charge of the electric energy storage is between an upper charge threshold and a lower charge threshold;
at an operation point providing more power than at the ideal operation point if the state of charge of the electric energy storage is smaller than the lower charge threshold; and
at an operation point providing less power than at the ideal operation point if the state of charge of the electric energy storage is greater than the upper charge threshold.

16. The agricultural machine of claim 11, wherein the control unit is configured to determine the set engine state of the engine additionally based on the state of charge of the electric energy storage.

17. The agricultural machine of claim 11, wherein the control unit is configured to
determine a current engine state of the engine; and
determine the set engine state of the engine additionally based on the current engine state of the engine.

18. A method for controlling an engine of an agricultural system comprising:
determining a maximum total system efficiency of the agricultural system;
determining an ideal operation point of the engine in accordance with the maximum total system efficiency;
controlling the engine to operate the engine at the ideal operation point of the engine.
